(19) United States
(12) Patent Application Publication
(10) Pub. No.: US 2002/0105281 A1
(43) Pub. Date: Aug. 8, 2002

(54) Wiring, laying in a serpentine reversing path, and controlling lights of a decorative light string so as to present two-dimensional marching line and chevron patterns

(76) Inventor: Renato Openiano, San Diego, CA (US)

Correspondence Address: FUESS & DAVIDENAS, Suite II-G, 10951 Sorrento Valley Road, San Diego, CA, 92121-1613, US

(21) Appl. No.: 10/066,017

(22) Filed: Feb. 1, 2002

Related U.S. Application Data
(60) Provisional application No. 60/266,362, filed on Feb. 3, 2001.

(51) Int. Cl. H05B 37/00

(52) U.S. Cl. 315/185 R; 315/185 S

(57) ABSTRACT

A single string of decorative lights is laid out in a reversing serpentine path of consecutive oppositely-directed parallel line segments, the collective line segments of lights typically forming a rectangular grid array. The lights within consecutive segments alternate between being wired (i) repetitively stepwise ascending, for example (A, B, C, D), (A, B, C, D), etc., and (ii) repetitively stepwise descending, for example (D, C, B, A), (D, C, B, A), etc. A controller sequentially energizes, for example, all lights A followed by all lights B, followed by all lights C, followed by all lights D. Similar, or congruent, two-dimensional patterns, normally line segments or chevrons (arrowheads), will appear to move from location to location to location as the lights are sequentially energized.

The present patent application is descended from, and claims benefit of priority of, U.S. provisional patent application Serial No. 60/266,362 filed on Feb. 3, 2001 for a SINGLE STRING OF MULTI-STRAND/MULTI-CIRCUIT DECORATIVE LIGHTS SYSTEM CONTINUOUSLY FORMED INTO MULTIPLE PARALLEL LINES OF LIGHTS HAVING IDENTICAL DIRECTIONAL LIGHT EFFECTS MOVEMENT OF LIGHTS ON ALL THE LINES to the selfsame inventor as the present patent application.

### BACKGROUND OF THE INVENTION

1. Field of the Invention

The present invention generally concerns decorative lights in strings, such as common Christmas tree and festival lights.

The present invention particularly concerns the realization of two-dimensional light patterns, typically moving lines and chevrons and the like, from strings of one-dimensional lights.

2. Description of the Prior Art

Strings of small lights are one of the least inexpensive, most enduring, and most popular forms of Christmas, or festival, lights. These lights are literally made by the millions.

Under such light controllers are standard circa 2002, the electric lights of a string are commonly wired in regular sequence A, B, C, . . . N; repeat A, B, C . . . N; repeat A, B, C, . . . N and so on between respective ones of (i) a plurality of voltage distribution buses 1, 2, 3, . . . N and (ii) a single ground return.

As the voltage buses 1, 2, 3, . . . N are sequentially energized, all the lights A light, followed by the lights B, followed by the lights C and so on until lights N are lit, at which time the entire cycle starts again.

U.S. Pat. No. 5,747,940 issued May 5, 1998, for MULTI-DIMENSIONAL CONTROL OF ARRAYED LIGHTS TO PRODUCE SYNCHRONIZED DYNAMIC DECORATIVE PATTERNS OF DISPLAY, PARTICULARLY FOR FESTIVAL AND CHRISTMAS LIGHTS to of the inventor of the present invention teaches that a plurality of separate, and separately controlled, ground buses may also be used for sequencing control of the lights. In that patent a number of voltage and ground buses—normally four or more each of which respectively connects to groups of lights within a large number of lights that are typically both multicolored and regularly geometrically arrayed in two and three dimensions—are separately simultaneously selectively energized in order to produce dynamic decorative patterns of display, particularly for use as Christmas lights. Buses are preferably selectively enabled and energized in at least four major and ten or more minor combinations in order to, along with differences in sequencing and phasing and timing, produce great numbers of different display patterns, typically at least ten such patterns that are recognizable to an observer. The progressive displays of a great number of individual light arrays may be coordinated in both (i) synchronization, and (ii) repetition rate, by the simple expedients of (i) applying a.c. line power to all light arrays in common at the same time, and (ii) selecting by wire jumpers a fundamental repetition rate at each light array.

Regardless of which energization sequencing technique is used, the lights which are lighting ones at a time produce separate points of light; giving a display of one-dimensional light sources. Although the points light display may be sequentially staged—i.e., red, blue, green, yellow, etc. and the like—the lights do not create a two (or three) dimensional pattern of the order of, for example, marquee lighting.

In marquee lighting—as is famously used circa 2002 in Los Vegas, Nev., U.S.A.—lines, arrows, chevrons and sometimes still other two-dimensional patters such as circles and squares may appear to move in position from one location to the next. These effects are obtained by complex light controllers which are at the present time, circa 2002, commonly based on computers controlling each and every light individually. These marquee lights are considered attractive, and it would be useful if some marquee patterns of display, perhaps the simpler moving line and arrow (chevron) display patterns, could somehow be realized with existing string light controllers and light strings.

### SUMMARY OF THE INVENTION

The present invention contemplates (i) laying out in a serpentine path, and (ii) controlling, one-dimensional lights in a string of decorative lights so that a two-dimensional pattern of marching lines, or chevrons (i.e., arrows), or the like will be visible to an observer.

1. A Method of Wiring, and Laying Out, a String of Decorative Lights

In one of its aspects the present invention is embodied in a method of wiring a string of decorative lights where some lights “A” of the string are energized at a first time, lights “B” of the same string are energized at a second time, lights “C” of the same string are energized at a third time and so on until lights “N−2” of the same string are energized at an N−2th time, lights “N−1” of the string are energized at an N−1th time, and lights “N” are energized at a final, Nth, time.

The method of wiring involves (i) first wiring in a first sequence one of the lights A followed by one of the lights B followed by one of the lights C and so on until one of the lights N−2 is followed by one of the lights N−1 is followed by one of the lights N, and then (ii) repeating this sequence A, B, C, . . . , N−2, N−1, N all over again for X times.

The method continues in (ii) second wiring in a second sequence one of the lights N followed by one of the lights N−1 followed by one of the lights N−2 and so on until one of the lights C is followed by one of the lights B is followed by one of the lights A, and (ii) repeating this sequence N, N−1, N−2, . . . , C, B, A all over again for X times.

The method continues with third wiring in the first sequence, and fourth wiring in the second sequence, and so on until, the lights of the string having been wired first in one sequence A, B, C, . . . , N−2, N−1, N for X times and then in another sequence N, N−1, N−2, . . . , C, B, A for X times until—alternating between sequences—all the lights of the string are wired.

This method of wiring the string of lights is commonly extended to arraying the string of lights so wired. Mainly, the wired lights of the lights of string of lights are laid out so that (i) lights of the first wiring proceed in a first direction along a first straight line segment until, the string of lights being bent back upon itself, while (ii) lights of the second wiring proceed in a second direction, opposite to the first direction, along a second straight line segment parallel to the first line segment, until, the string of lights being again bent back upon itself, (iii) lights of the subsequent wirings proceed in opposite directions along parallel line segments until all lights are maintained laid out in parallel line segments forming a rectangle. Being laid out in this manner, energization of the lights in the aforesaid sequence A, B, C, . . . (N−2), (N−1), N will produce a two-dimensional pattern.

2. An Array of Decorative Lights

In another of its aspects the present invention is embodied in a decorative array of lights that is particularly (i) wired, (ii) laid out, and (ii) energized.

In this aspect the invention is embodied a string of a multiplicity of lights (1) electrically wired 1a) first in stepwise ascending sequences (A, B, C, . . . , N−2, N−1, N) and then again (A, B, C, . . . , N−2, N−1, N) until the ascending sequence shall have been repeated X times, and then (1b) second in stepwise descending sequences (N, N−1, N−2, . . . , C, B, A) and then again (N, N−1, N−2, . . . , C, B, A) until the descending sequence shall have been repeated X times, and then (1c) repeating alternately the X stepwise ascending sequences and the X stepwise descending sequences until all the multiplicity of lights of the string are wired.

The same lights are then (2) laid out with the X stepwise ascending sequences in a first direction along a first line segment, followed by the X stepwise descending sequences in a second direction, opposite to the first direction, along a second line segment parallel to the first line segment, and so on one parallel line segment to the next with the lights of each line segment proceeding in opposite stepwise ascending and stepwise descending sequences.

Finally, the wired and laid out lights are (3) energized so that all lights A are energized at a first time, and then all lights B are energized at a second time, and then lights C are energized at a third time and so on until all lights N−2 are energized at an N−2th time, and then all lights N−1 are energized at an N−1th time and, finally, all lights N are energized at an Nth time.

By these steps a moving two-dimensional pattern will be displayed by the multiplicity of lights of the string of lights so wired, laid out and energized.

The laying out of the string of lights is preferably facilitated by a jig.

The moving two-dimensional pattern may be, for example, a straight line, or a chevron (arrowhead).

These and other aspects and attributes of the present invention will become increasingly clear upon reference to the following drawings and accompanying specification.

### BRIEF DESCRIPTION OF THE DRAWINGS

Referring particularly to the drawings for the purpose of illustration only and not to limit the scope of the invention in any way, these illustrations follow:

FIG. 1 illustrates how a number of lights of a single light string may be both (i) strung together and (ii) physically organized in position.

FIG. 2 is an electrical schematic of a variant embodiment of a circuit in accordance with the present invention where the lights are wired in series.

FIG. 3 is an electrical schematic of a variant embodiment of a circuit in accordance with the present invention where the lights are wired in parallel.

FIG. 4 is an electrical schematic of a variant embodiment of a circuit in accordance with the present invention where the lights are wired in series and in parallel.

FIG. 5 is a diagram showing an organization of lights for producing visual right diagonal light patterns.

FIG. 6 is a diagram showing an organization of lights for producing visual left diagonal light patterns.

FIG. 7 is a diagram showing an organization of lights for producing visual vertical light patterns.

FIG. 8 is a diagram showing an organization of lights for producing visual left pointing arrowhead light patterns.

FIG. 9 is a diagram showing an organization of lights for producing visual right pointing arrowhead light patterns.

FIG. 10 is a diagram showing an organization of lights for producing visual right pointing blunt tipped arrowhead light patterns.

FIG. 11 is a diagram showing an organization of lights for producing visual left pointing blunt tipped arrowhead light patterns.

FIG. 12 is a diagram showing an organization of lights for producing jagged light patterns.

### DESCRIPTION OF THE PREFERRED EMBODIMENT

The following description is of the best mode presently contemplated for the carrying out of the invention. This description is made for the purpose of illustrating the general principles of the invention, and is not to be taken in a limiting sense. The scope of the invention is best determined by reference to the appended claims.

Although specific embodiments of the invention will now be described with reference to the drawings, it should be understood that such embodiments are by way of example only and are merely illustrative of but a small number of the many possible specific embodiments to which the principles of the invention may be applied. Various changes and modifications obvious to one skilled in the art to which the invention pertains are deemed to be within the spirit, scope and contemplation of the invention as further defined in the appended claims.

The subject of this patent application is an improved single string of multi-strand/multi-circuit decorative lights continuously formed into multiple parallel lines of lights so that the lights so powered and arrayed may visually produce light effects. The effects produced are most commonly of the nature of the movement of two-dimensional patterns, such a multiple parallel lines.

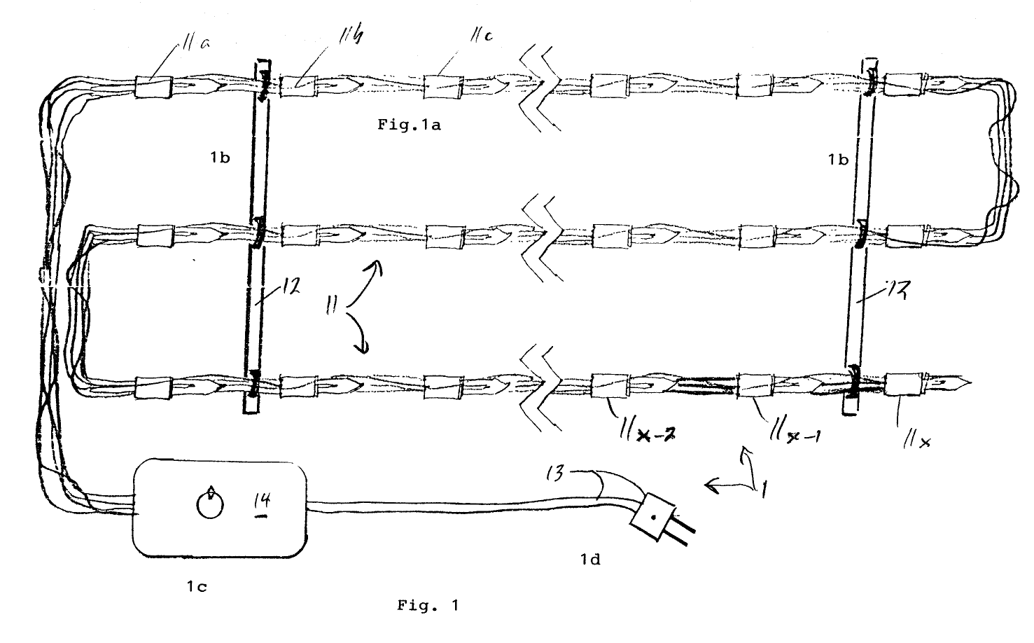

A preferred embodiment of a decorative lights assembly 1 in accordance with the present invention is diagrammatically shown in FIG. 1. The light assembly 1 is preferably comprised of four parts, namely, a large number of lights 11a-11x strung together in a particular sequence to be explained so as to form a single light string 11, spacer elements 12, an A.C. plug and cord 13, and an electronic controller circuit 14. The spacer elements 12 are the only things initially highly visually distinctive, although careful study of the light string 11 will reveal it to be wired differently from a conventional string of lights.

This plurality of circuits of lights lia-lix strung together to form a single string 11 is comprised of plurality of lights, preferably miniature lights, in which each the lights are grouped and connected together in a number of circuits, which circuits are connected together with associated circuits throughout the entire length of the light string. Each of the circuits has the same, or approximately the same, number of lights.

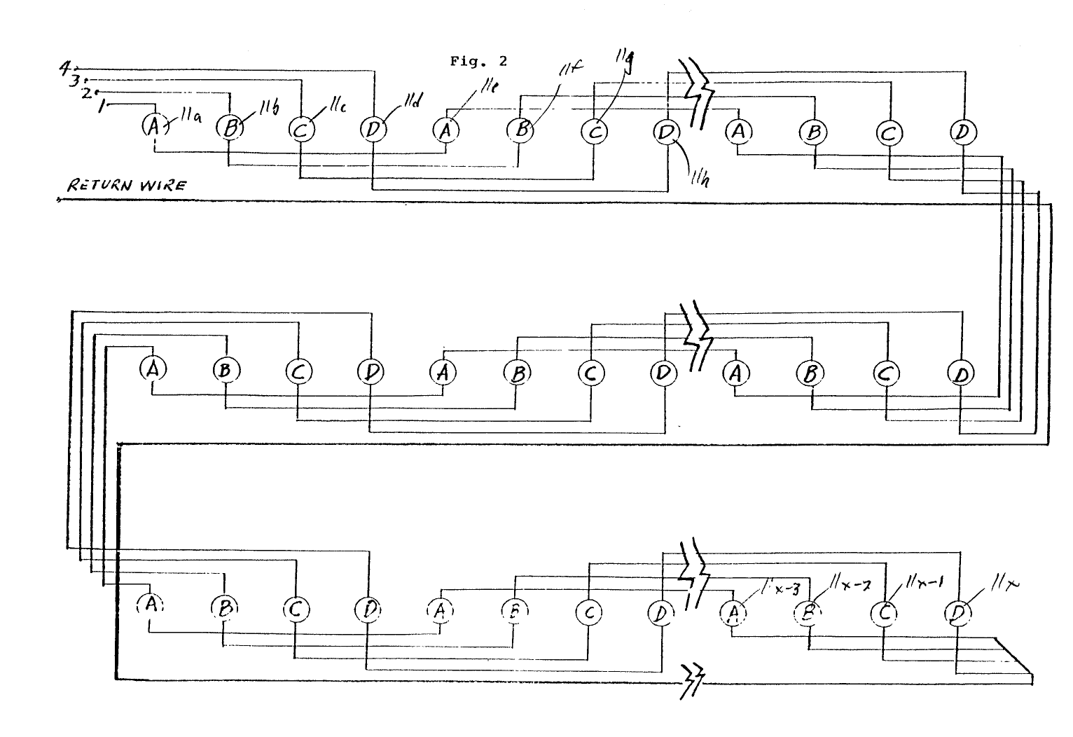

Referring now to FIG. 2, the lights belonging to circuit 1 are referred light. The lights belonging to circuit 2 are referred to as B lights, the lights belonging to circuit 3 are referred to as C lights. Still other lights belonging to circuit 4, 5, 6 and above if so used would be respectively referred to as D, E, F and so on lights. The controller 14 (seen in FIG. 1) energizes circuit 1 and all the lights A, followed by circuit 2 and all the lights B, and so on in rotation until, the last circuit being energized, the entire sequence starts over again with circuit 1.

In accordance the present invention, the lights so wired are placed in a number of parallel lines as illustrated in FIGS. 2-12. The parallel lines are numbered 1, 2, 3, etc. top to bottom, with the line nearest to the top of each figure being referred to as line 1. The lights in this line 1, and in any subsequent odd-numbered parallel lines—referred to as lines 3, 5 and so on to the extent used—follow a pattern whereby the first light in line is wired to circuit 1 and is thus an A light, the second light in line is wired to circuit 2 and is thus a B light, and so on, the (A, B, C, D, and so on as used) pattern repeating stepwise as illustrated in lines 1 and 3 of FIG. 2. That is, the lights of all circuits of odd numbered lines will be placed in order as a sequence (A, B, C, (and D, E, F, etc. if used)), followed by second sequence (A, B, C, (and D, E, F, etc. if used)), followed by a third sequence (A, B, C, (and D, E, F if used)) and so forth. The distance between successive lights in the string is preferably approximately standard throughout the line so as to create uniformity, this distance being dictated by the design and the respective length of the inter-connecting wires between the lights of each circuit.

Note next that a line 2 is formed below line 1 and above line 3, and is parallel to line 1 and line 3. Lines 2, 3, etc. are formed by creating a “U” type turn at the end of the preceding line, as illustrated in the drawings including FIG. 2. The placement of the lights for line 2 and all other, subsequent, even-numbered lines are each a mirror image of line 1 and all the other odd-numbered lines. Namely, the order of placement of the lights for the even-numbered lines is, from earlier to later along the string, from higher to lower among the lights. For example, in FIG. 2, the sequence (D, C, B, A) is followed by another sequence (D, C, B, A) is followed by a third sequence (D, C, B, A).

The lights of alternate parallel lines thus alternate being stepwise increasing—i.e., (A, B, C, D), (A, B, C, D), etc.—and stepwise decreasing—i.e., (D, C, B, A), (D, C, B, A), etc. At the end of each line a “U”-turn is made so as to form another line below and parallel to the preceding line. The distance between each of the parallel lines is preferably uniform, and is preferably established by a spacer 12 (seen in FIG. 1) of the like that is preferably made of plastic or the like. The spacer 12 preferably acts as a jig to hold in position the parallel lines by removably attaching the lines with clips or the like. A common return wire normally connects the circuits of all lights to a common, normally an A.C., bus.

In operation of the strings of lights illustrated in FIGS. 1-12, the electronic light controller 14 (shown in FIG. 1) selectively successively connects a first end of each light circuit to the A.C. voltage bus. The selective application of A.C. voltage to any of the lights causes the light to illuminate. The stepwise sequential illumination of the collective lights creates two-dimensional light effects in the form of moving, or marching, lines (stripes), chevrons (arrowheads) or the like (as is predetermined).

The multiplicity of lights may be wired in series as shown in FIG. 2 or in parallel as shown in FIG. 3. It makes no different to the principles, and to the operation, of the present invention.

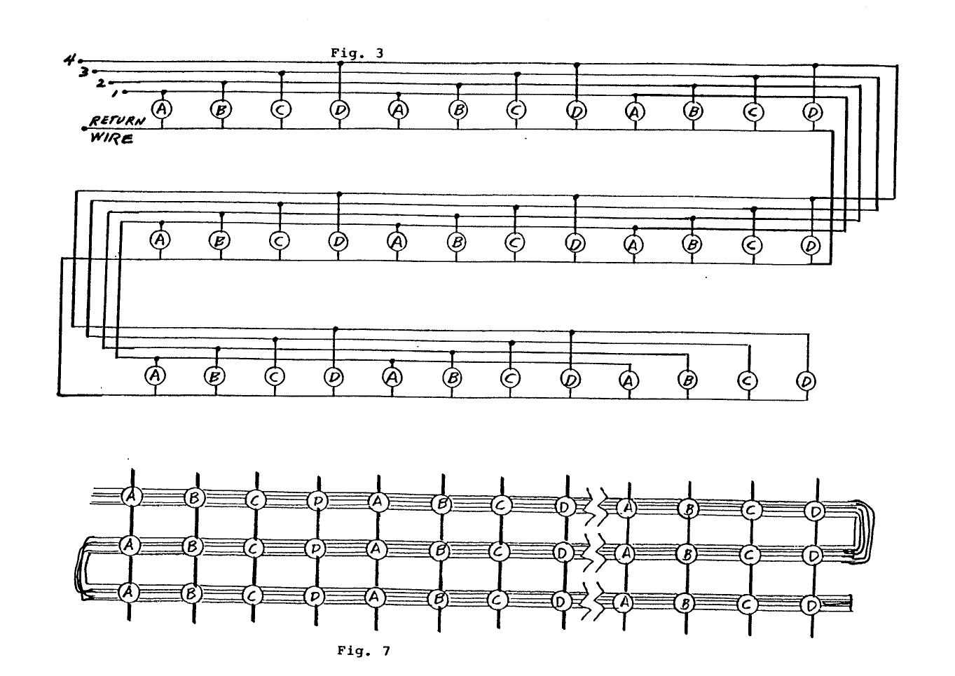

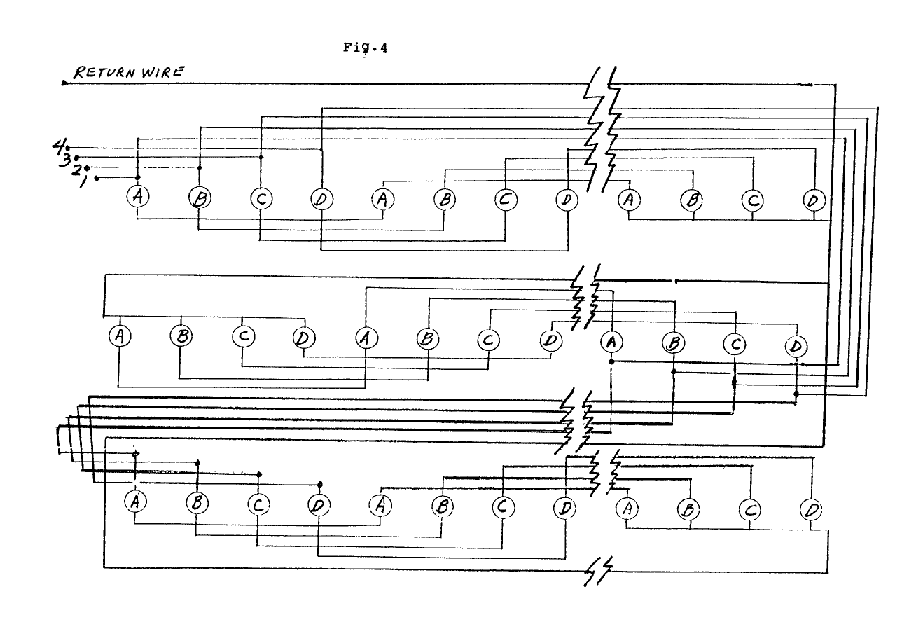

The lights may even be wired in both series and parallel as shown in FIG. 4.

A light assembly in accordance with the present invention as previously described and explained where the pattern produced is, in particular, a right diagonal line is shown in FIG. 5. This pattern arises when A.C. power is selectively sequentially applied to circuits 1, 2, 3 and lines 4 (and so forth onto still further circuits if such are used). The visual right diagonal light patterns so formed are preferably (1) parallel to each other and (2) similar in geometrical shape. They are more preferably (2a) congruent with each other—as is the case illustrated in FIG. 5.

Another light assembly in accordance with the present invention as previously described and explained where the pattern produced is a visual left diagonal line is shown in FIG. 6. This pattern arises when A.C. power is selectively sequentially applied to circuits 1, 2, 3 and lines 4 (and so forth onto still further circuits if such are used). The visual left diagonal light patterns so formed are preferably (1) parallel to each other and (2) similar in geometrical shape. They are more preferably (2a) congruent with each other—as is the case illustrated in FIG. 6.

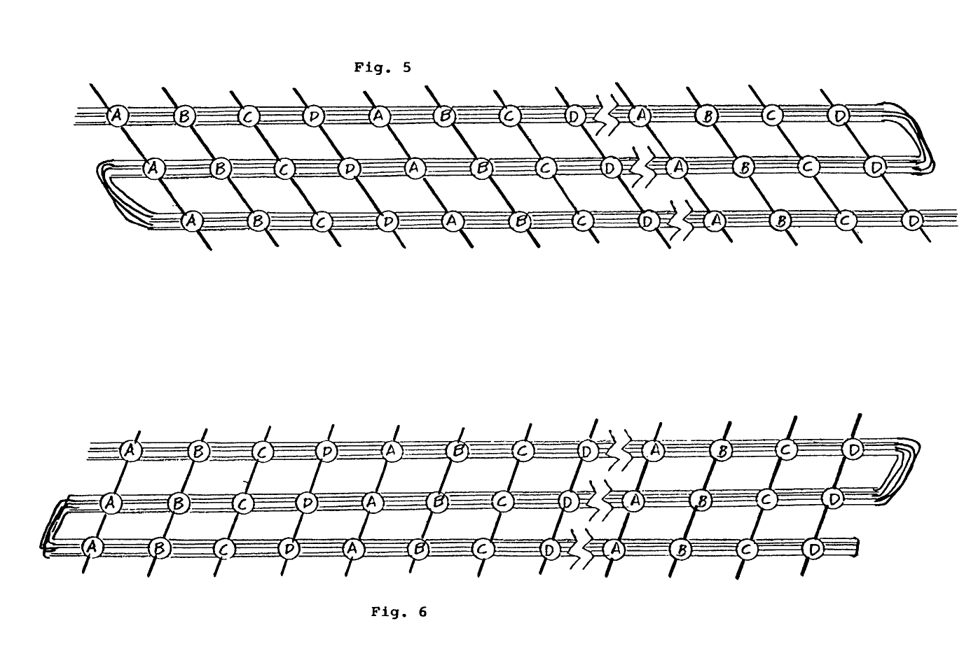

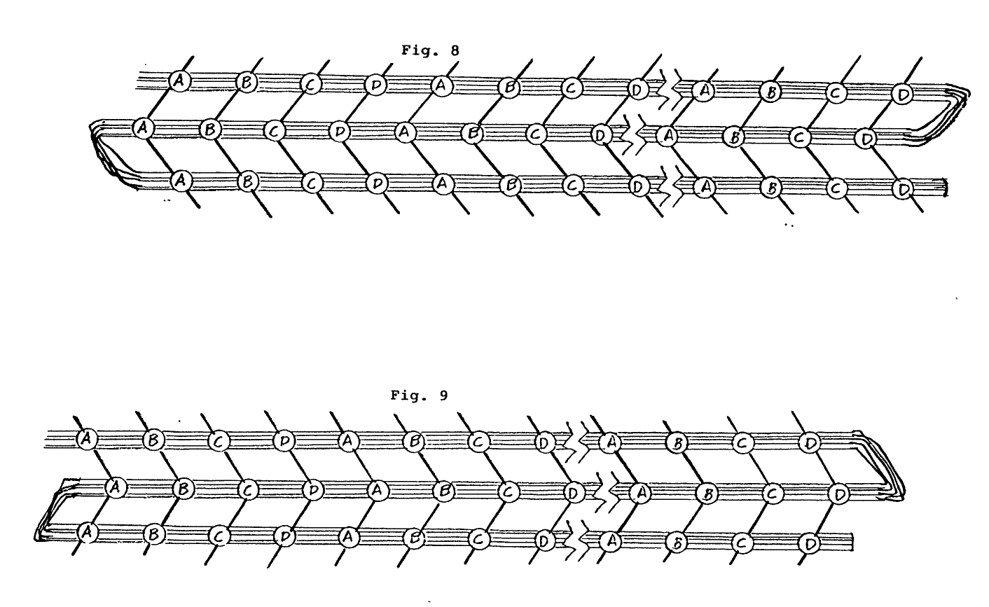

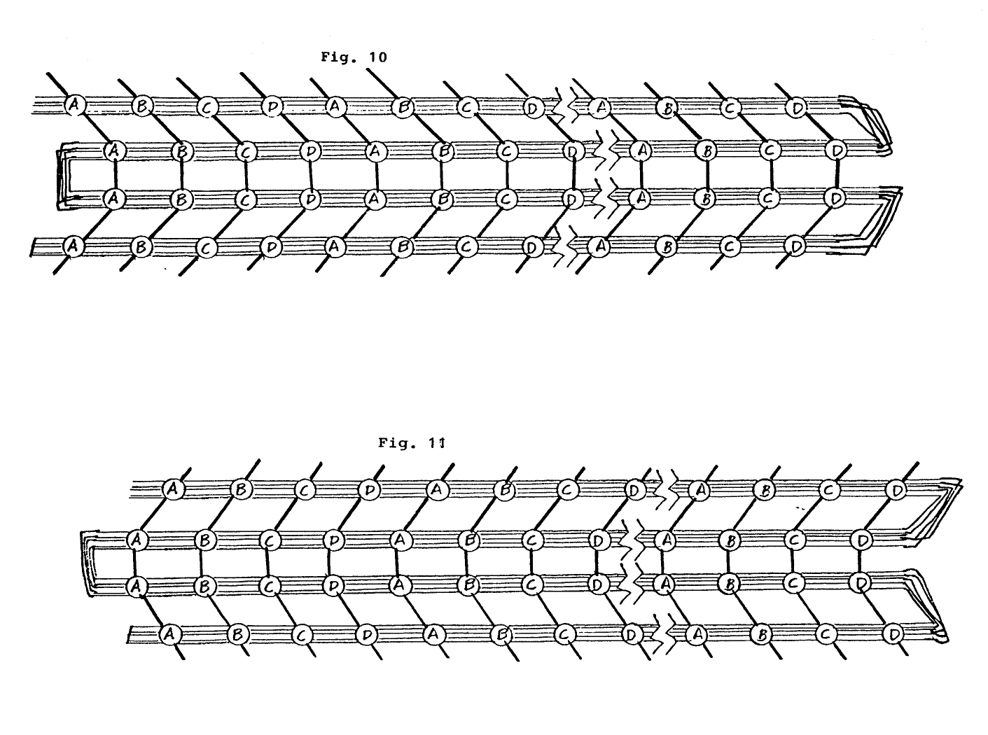

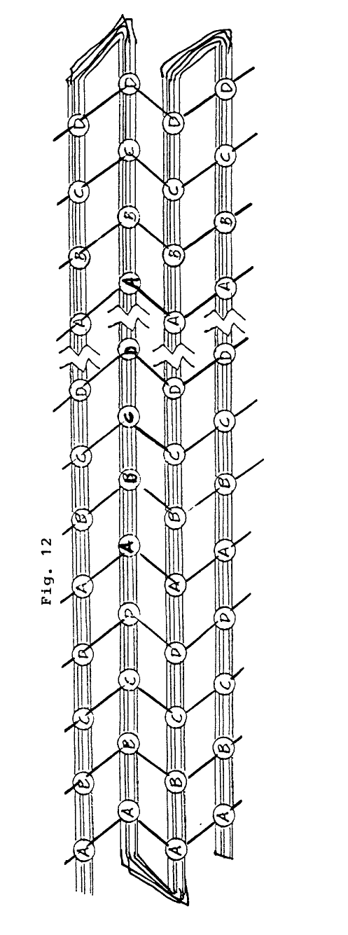

Similarly, the generation of vertical light patterns is shown in FIG. 7; the generation of left pointing arrowheads, or chevrons, in FIG. 8; the generation of right pointing arrowheads, or chevrons, in FIG. 9. Further similarly, the generation of right pointing blunt-tipped arrowheads is shown in FIG. 10, and the generation of left-pointing blunt-tipped arrowheads in FIG. 11. The light assembly 1 can even be use to produced jagged light patterns of line segment that are parallel to each other as illustrated in FIG. 11.

In accordance with the preceding explanation, variations and adaptations of the light string assembles in accordance with the present invention will suggest themselves to a practitioner of the electrical and festival lighting arts.

In accordance with these and other possible variations and adaptations of the present invention, the scope of the invention should be determined in accordance with the following claims, only, and not solely in accordance with that embodiment within which the invention has been taught.

What is claimed is:

1. Where a plurality of lights A of a string of lights are energized at a first time, a plurality of lights B of the same string of lights are energized at a second time, a plurality of lights C of the same string of lights are energized at a third time and so on until a plurality of lights N−2 of the same string of lights are energized at an N−2th time and a plurality of lights N−1 of the same string of lights are energized at an N−1th time and a plurality of lights N of the same string of lights are energized at a final Nth time, a method of wiring a string of lights comprising:
first wiring in a first sequence one of the lights A followed by one of the lights B followed by one of the lights C and so on until one of the lights N−2 is followed by one of the lights N−1 is followed by one of the lights N, and repeating this sequence A, B, C, . . . N−2, N−1, N all over again for X times; and then continuing in the lights of the string
second wiring in a second sequence one of the lights N followed by one of the lights N−1 followed by one of the lights N−2 and so on until one of the lights C is followed by one of the lights B is followed by one of the lights A, and repeating this sequence N, N−1, N−2, . . . , C, B, A all over again for X times;
wherein all the lights of the string are wired stepwise in alternating sequences.

2. The method of wiring the string of lights according to claim 1 further comprising:
third wiring in the first sequence, and
wherein the lights of the string are wired stepwise (i) first in sequence A, B, C, . . . , N−2, N−1, N for X times, and (ii) then in a sequence N, N−1, N−2, . . . , C, B, A for X times, and (iii) further in the sequence A, B, C, . . . , N−2, N−1, N for X times until all the lights of the string are wired.

3. The method of wiring the string of lights according to claim 1 further comprising:
third wiring in the first sequence, and
fourth wiring in the second sequence, and so on
until, the lights of the string have been wired first in a sequence A, B, C, . . . , N−2, N−1, N for X times, and then in a second sequence N, N−1, N−2, . . . , C, B, A for X times, and so on alternating from one sequence to the other until all the lights of the string are wired.

4. The method of wiring the string of lights according to claim 3 extended to arraying the string of lights so wired, the wiring and arraying method further comprising:
maintaining laid out the lights of string of lights so that
lights of the first wiring proceed in a first direction along a first straight line segment until, the string of lights being bent back upon itself,
lights of the second wiring proceed in a second direction, opposite to the first direction, along a second straight line segment parallel to the first line segment until, the string of lights being bent back upon itself,
lights of each of one or more subsequent wirings each proceed in opposite directions along parallel line segments until all lights are maintained laid out in parallel line segments forming a rectangle;
wherein energization of the lights will produce a two-dimensional pattern.

5. The method of wiring the string of lights according to claim 1 extended to arraying the string of lights so wired, the wiring and arraying method further comprising:
maintaining laid out the lights of string of lights so that
lights of the first wiring proceed in a first direction along a first straight line segment until, the string of lights being bent back upon itself,
lights of the second wiring proceed in a second direction, opposite to the first direction, along a second straight line segment parallel to the first line segment;
wherein energization of the lights will produce a two-dimensional pattern.

6. A string of a multiplicity of lights electrically wired
first in stepwise ascending sequences (A, B, C, . . . , N−2, N−1, N) and then again (A, B, C, . . . , N−2, N−1, N ) until the ascending sequence shall have been repeated X times, and then
second in stepwise descending sequences (N, N−1, N−2, C, B, A) and then again (N, N−1, N−2, . . . , C, B, A) until the descending sequence shall have been repeated X times, and then
repeating alternately the X stepwise ascending sequences and the X stepwise descending sequences until all the multiplicity of lights of the string are wired;
laid out with the X stepwise ascending sequences in a first direction along a first line segment, followed by the X stepwise descending sequences in a second direction, opposite to the first direction, along a second line segment parallel to the first line segment, and so on one parallel line segment to the next with the lights of each line segment proceeding in opposite stepwise ascending and stepwise descending sequences; and
energized so that all lights A are energized at a first time, and then all lights B are energized at a second time, and then lights C are energized at a third time and so on until all lights N−2 are energized at an N−2th time, and then all lights N−1 are energized at an N−1th time and, finally, all lights N are energized at an Nth time;
wherein a moving two-dimensional patter will be displayed by the multiplicity of lights of the string of lights so wired, laid out and energized.

7. The string of lights according to claim 6 wherein the string of light is laid out on a jig.

8. The string of lights according to claim 6 wherein the moving two-dimensional pattern is a straight line.

9. The string of lights according to claim 6 wherein the moving two-dimensional pattern is a chevron.

10. A string of N decorative lights laid out in a serpentine path so that
lights numbers (1, 1+X, 1+2X, 1+3X, . . . , N−X+1) in first line, are followed in the first line by lights numbers (2, 2+X, 2+2X, 2+3X, . . . , N−X+2), are further followed in the first line by lights numbers (3, 3+X, 3+2X, 3+3X, . . . , N−X+3) and so on
until a number A, A<N is reached, at which time (i) the lights are routed in a second line parallel to and alongside the first line, where (ii) lights numbers (N−X+1+A, . . . , A+1+3X, A+1+2X, A+1+X, A+1} in the second line are followed in the second line by said lights numbers (N−X+2+A, . . . , A+2+3X, A+2+2X, A+2+X, A+2) are further followed in the second line by said lights numbers (N−X+3+A, . . . , A+3+3X, A+3+2X, A+3+X, A+3) and so on
until a number B, A<B<N is reached, at which time (i) the lights are routed in a third line parallel to and alongside the first and the second lines, where (ii) lights numbers (B+1, B+1+X, B+1+2X, B+1+3X, . . . , N−X+1+B) in the third line are followed in the third line by said lights numbers (B+2, B+2+X, B+2+2X, B+2+3X, . . . , N−X+2+B), are further followed in the third line by said lights numbers (B+3, B+3+X, B+3+2X, B+3+3X, . . . , N−X+3+B) and so on,
the lights proceeding in parallel lines where the lights of each line are staged oppositely.

11. The string of N decorative lights laid out in a serpentine path according to claim 10
wherein all lights (1, 2, 3, . . . , A+1, A+2, A+3, . . . , B+1, B+2, B+3) are energized followed by all lights (1+X, 2+X, 3+X, . . . , A+1+X, A+2+X, A+3+X, . . . , B+1+X, B+2+X, B+3+X) followed by all lights (1+2X, 2+2X, 3+2X, . . . , A+1+2X, A+2+2X, A+3+2X, . . . , B+1+2X, B+2+2X, B+3+2X) and so on;
wherein between and among all the lights a moving two-dimensional pattern is displayed.
